(19) United States
(12) Patent Application Publication
(10) Pub. No.: US 2005/0007959 A1
(43) Pub. Date: Jan. 13, 2005

(54) Information processing apparatus and control method of information processing apparatus and program for the same

(75) Inventors: Shigenori Tomonaga, Yokohama (JP); Hiroshi Yokouchi, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/652,986

(22) Filed: Aug. 28, 2003

(30) Foreign Application Priority Data
May 19, 2003 (JP) 2003-140221

(51) Int. Cl. H04L 12/26

(52) U.S. Cl. 370/248

(57) ABSTRACT

A program for use in an information processing apparatus is disclosed. The apparatus has the function of displaying at a user interface a plurality of information items concerning a communication path for sending a data input/output request to a storage device. The program permits the apparatus to execute at least either one of the steps which follow: updating at least one of the information items being displayed in accordance with a present state of the communication path, and updating at least one of the information items being displayed when receiving from the user interface an input which requests updating of the information being displayed.

### BACKGROUND OF THE INVENTION

1. Field of the Invention

The present invention relates to a program, an information processing apparatus, and a control method of information processing apparatus.

2. Description of the Related Art

In recent years, data to be processed by computer systems are increasing in amount more and more, and storage systems grow to offer increased storage capacities. Thus, it is necessary for large-capacity storage systems to achieve enhanced input/output performance and reliability which may support such increased storage capacities.

To do this, a technique has been developed for multiplexing communication paths for transmitting a data input/output request from a computer toward a storage system to thereby improve the input/output performance while at the same time improving the reliability.

Such computer system is designed to have an ability to visually display certain information concerning the communication paths at a user interface of the computer.

One approach to the system design is disclosed, for example, in Published Japanese Patent Application No. 2002-63063 (JP-A-2002-63063).

However, the information items as to these communication paths would include ones that are required to be rapidly updated and the others that are free from such requirement. In addition, as the computer system increases in scale, the information as to the communication paths to be displayed becomes larger in amount accordingly. Prior art technologies lack specific consideration for processing loads as given to the computer when updating these display contents and also consideration for rapidly performing the updating tasks required.

The present invention has been made in view of the above technical background, and its primary object is to provide a program, information processing apparatus and control methodology of information processing apparatus.

### SUMMARY OF THE INVENTION

To attain the foregoing object, in accordance with one aspect of this invention, a program is provided which is for use in an information processing apparatus having the function of displaying at a user interface a plurality of information items concerning a communication path for sending a data input/output request to a storage device. The program causes the apparatus to execute at least either one of the steps of updating at least one of the information items being displayed in accordance with a present state of the communication path, and updating at least one of the information items being displayed when receiving from the user interface an input for updating the information a being displayed.

The storage device as used herein should be interpreted to include, for example, a hard disk device and/or a semiconductor memory device or equivalents thereto, which has storage resources for provision to the information processing apparatus and also include a control device for controlling them in accordance with a data input/output request as received from the information processing apparatus. The information processing apparatus may typically be a computer which has a central processing unit (CPU) and more than one memory to thereby offer the capability to execute various types of software programs. The user interface may refer to an input device and/or an output device as equipped by the information processing apparatus or alternatively an input device and/or output device as built in another information processing apparatus that is connected to the information processing apparatus. In addition, the communication path includes, for example, a physical path which is physically made up of hardware components for connection between the information processing apparatus and the storage device, and a logical path which is logically set up to the physical path.

These and other objects, features and advantages of the invention will be apparent from the following more particular description of preferred embodiments of the invention, as illustrated in the accompanying drawings.

### BRIEF DESCRIPTION OF THE DRAWINGS

FIG. 1 is a block diagram showing an overall configuration of an information processing system in accordance with an embodiment of the invention.

FIG. 2 is a diagram for explanation of paths for connection between a storage system and an information processing apparatus in accordance with this embodiment.

FIG. 3 is a diagram showing a path information management table in accordance with the embodiment.

FIG. 4 is a diagram showing a error path information table in accordance with the embodiment.

FIG. 5 is a diagram showing an input/output (I/O) management table in accordance with the embodiment.

FIG. 6 is a block diagram showing an information processing apparatus in accordance with the embodiment.

FIG. 7 is a diagram showing a path management method in a path management program in accordance with the embodiment.

FIG. 8 is a flow chart showing a flow of processing when adding a path in accordance with the embodiment.

FIG. 9 is a flowchart showing a processing flow when detecting a path in accordance with the embodiment.

FIG. 10 is diagram showing constituent parts or components which make up a path in accordance with the embodiment.

FIG. 11 is a diagram showing an on-screen display arrangement in accordance with the embodiment.

FIG. 12 is a diagram showing a flow of input/output processing when the individual path is normal in accordance with the embodiment.

FIG. 13 is a diagram showing one possible situation of the input/output processing upon occurrence of obstruction at a path in accordance with the embodiment.

FIG. 14 is a diagram showing one situation during error path check in accordance with the embodiment.

### DETAILED DESCRIPTION OF THE INVENTION

An embodiment of the present invention will now be described in detail with reference to the accompanying drawings below.

===Overall Configuration Example===

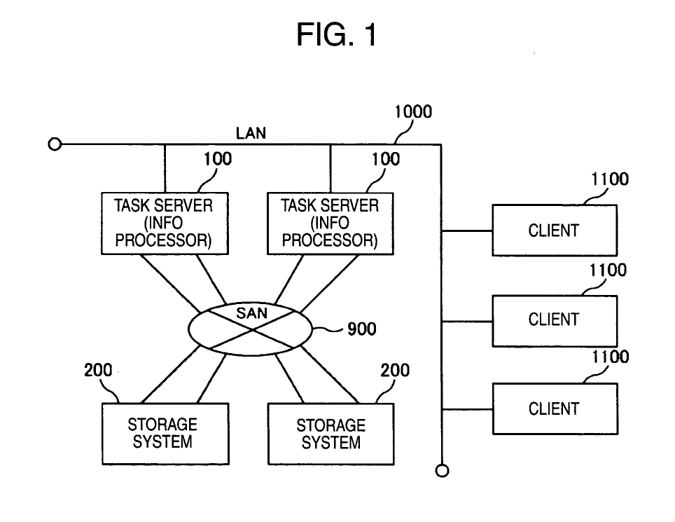

Firstly, an overall configuration of an information processing system in accordance with one embodiment of this invention is illustrated in block diagram form in FIG. 1.

Business task or “enterprise” clients 1100 are connected via a local area network (LAN) 1000 to business task servers (each corresponding to information processing apparatus as claimed) 100, also known as enterprise servers. A respective one of the task servers 100 and task clients 1100 is a computer which has a central processor unit (CPU), a memory, an input/output device, and others. Task servers 100 are operable to provide a variety of kinds of information providing services by utilizing the storage resources that are provided from storage systems 200, which are connected thereto via a storage area network (SAN) 900. Whereby, the individual client 1100 is capable of receiving information processing services to be provided by any one of the task servers 100 involved. Additionally the LAN 1000 may be designed in the form of a public network, such as the Internet, or alternatively a private network.

The information processing services to be provided by the task servers 100 should not be limited to any specific services. For example, various kinds of services are considered, including but not limited to online services, such as automated cash dispensing services at banks and web page browsing services over the Internet, and also batch processing services for execution of experimental simulation in scientific and engineering fields.

===Task Server (Information Processing Apparatus)===

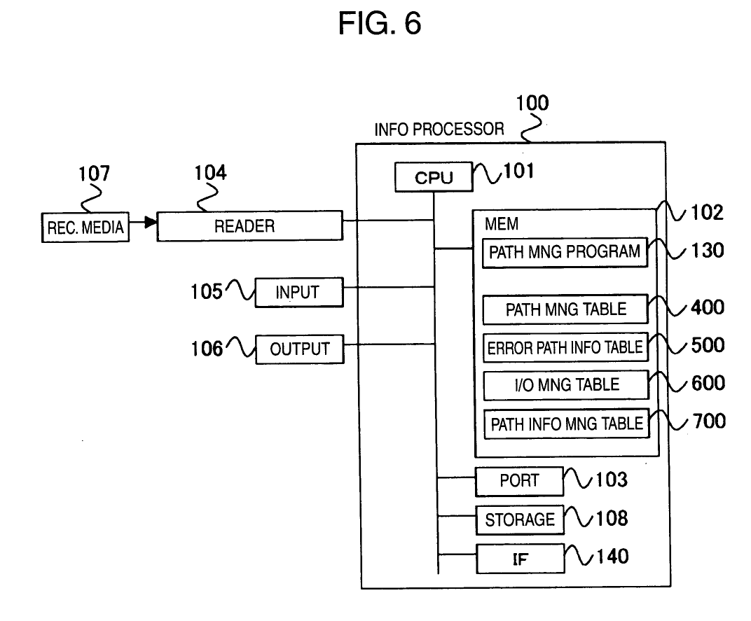

The individual information processing apparatus 100 is a computer which includes a CPU and a memory for executing various types of application programs 120 and a path management program 130. A configuration of the information processing apparatus 100 in accordance with this embodiment is shown in block form in FIG. 6.

The information processing apparatus 100 is equipped with a CPU 101, a memory 102, a port 103, a recording media reading device 104, an input device 105, an output device 106, a storage device 108, and an interface (IF) 140.

The CPU 101 is the one that provides control over the entirety of the information processing apparatus 100. CPU 101 is operable to read the path management program 130 as stored in the storage device 108 into the memory 102 in any appropriate events and then execute this program, thereby performing control of the path 300 which is a communication channel for sending a data input/output request from the information processing apparatus 100 toward any one of the storage systems 200. The control of the path 300 per se will be described in detail later. In addition, the memory 102 stores therein a path management table 400, a troubled or error path information table 500, an input/output (I/O) management table 600, and a path information management table 700. These tables are appropriately updated and referred by the path management program 130 whenever a need arises in order to perform the control of path 300. These tables will be described later.

The recording media reading device 104 is a device that reads out of a record carrier body 107 a program and data as recorded thereon. The readout program and data are then stored in the memory 102 and/or the storage device 108. Thus it is possible, for example, to read the path management program 130 thus recorded on the recording media 107 out of the recording media 107 by use of the recording media reader device 104 and then store them in the memory 102 and/or the storage device 108. Typical examples of the recording media 107 are a flexible disk or disc, compact disk read only memory (CD-ROM), digital versatile disk read only memory (DVD-ROM), semi-conductor memory and other similar suitable ones. The media reader 104 may be designed in the form that this reader is built in the information processing apparatus 100 or alternatively designed in the form of externally connectable equipment. The storage device 108 stores therein the path management program 130 and various application programs 120 and the like. Examples of the storage device 108 include a fixed or “hard” disk drive unit and a semiconductor memory device. The input device 105 is one of user interfaces, which is used for data input or else to the information processing apparatus 100 by an operator or the like. Examples of the input device 105 are a keyboard unit and a pointing device called the mouse. The output device 106 is one user interface which is for outputting information. Examples of the output device 106 are a display unit and a printer. The port 103 is a device for performing communication with another information processing apparatus 100 and any one of the task clients 1100. In this case, it may also be arranged to receive the path management program 130 from the another information processing apparatus 100 via the port 103 and then store it in the memory 102 and/or the storage device 108, by way of example. The interface (IF) 140 is a communication interface between the information processing apparatus 100 and one of the storage systems 200. The IF 140 is provided by a host bus adapter, as an example. IF 140 is one of the components making up the path 300. Details will be described later.

The individual task client 1100 also is a computer with its CPU and memory and other components, the configuration of which is similar to that of the task server 100. Due to this, it is also possible to store the path management program 130 in the memory or the like of the task client 100 to thereby perform control of the paths 300 from any one of task clients 1100 while visually displaying the information as to the paths 300 at the user interface of such task client 1100.

The task servers 100 are connected to their associative storage systems 200 via the storage area network (SAN) 900. Communications between the task servers 100 and the storage systems 200 to be performed via the SAN 900 may be designed to comply with various types of communication protocols. Examples thereof are fiber channels, Small Computer System Interface (SCSI), Fibre Connection (FICON) (registered trademark), Enterprise System Connection (ESCON) (registered trademark), Advanced Connection Architecture (ACONARC) (registered trademark), Fibre Connection Architecture (FIBARC) (registered trademark), Transmission Control Protocol/Internet Protocol (TCP/IP), Internet SCSI (iSCSI), and equivalents thereto. More than two of these communication protocols may be co-used together.

The storage systems 200 provide the storage resources as required whenever any one of the task servers 100 attempts to provide information processing services to an aimed one or ones of the task clients 1100. The storage resources are provided by disk drive units that are built in the storage systems 200. Various examples employable as the disk drives are hard disk devices and semiconductor memory devices and equivalents thereof.

===Regarding Communication Path===

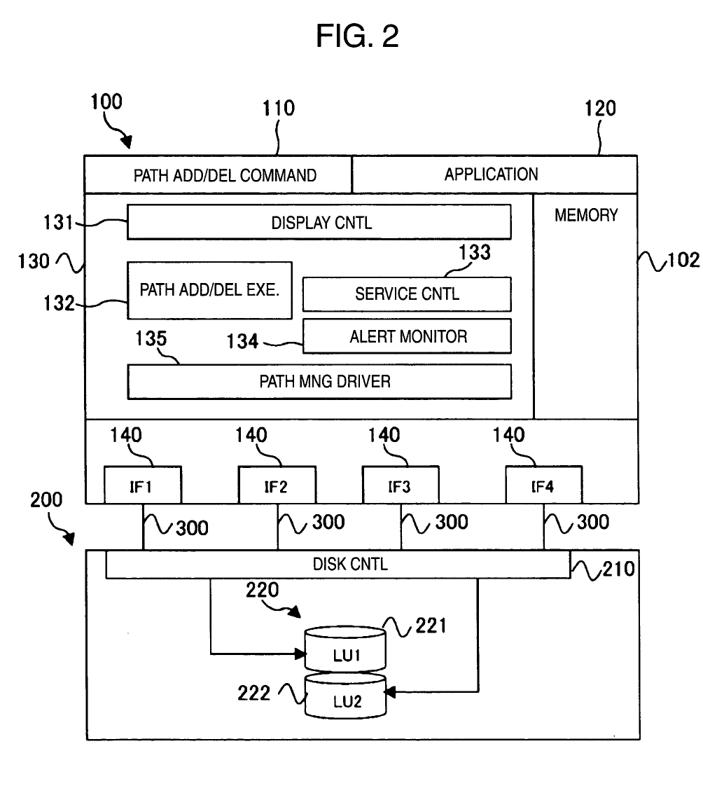

An explanation will next be given of the paths (communication channels) 300 for connection between one of the storage systems 200 and one of the information processing apparatuses 100 in accordance with this embodiment while referring to FIG. 2 below.

The information processing apparatus 100 performs access to the data being presently stored in the storage system 200 when it executes the application program 120. This data access is performed by transmitting a data input/output request from the information processor apparatus 100 to the storage system 200. The data input/output request transmission is done via more than one of the paths 300 (communication channels) linked between the information processor 100 and storage system 200. The path 300 is a communication channel between the information processor 100 and storage system 200, which includes both a physical path that is physically constituted from hardware components for connection between the information processor 100 and storage system 200 and a logical path that is logically set up to the physical path. As shown in FIG. 2, the information processing system in accordance with the illustrative embodiment has four paths 300, wherein the data input/output request from the information processor 100 is sent forth to the storage system 200 while being distributed among these four paths 300 under control of the path management program 130. Note here that the information processor 100 and storage system 200 may be directly connected together by such four paths 300 as shown in FIG. 2. Alternatively these are connectable via the SAN 900 with switches disposed therebetween.

===About Path Management Program===

The path management program 130 is a software program which controls communications for data input/output to be performed via the paths 300 between any one of the information processor apparatus 100 and any one of the storage systems 200 to thereby enable multiplexing of the paths 300. For example, this program performs settings such as addition and deletion of a path or paths 300 and also performs transmission of a data input/output request from the application program 120 while letting the request be distributed among four respective path lines 300 to thereby achieve load dispersion, also known as “load sharing.” Whereby, it is possible to eliminate the bottleneck in communications between the information processors 100 and storage systems 200, thereby enabling the information processing system to improve in performance. Additionally, the above-noted distribution may be performed while putting equal assignment to each path 300 or may alternatively be done at variable assignment rates in accordance with the kind of application program 120 and/or a present access destination of the data input/output request. Still alternatively, it is also possible when obstruction occurs at a path 300 to let this path 300 be out of use and then send the data input/output request while forcing it to pass along another normal path 300 that is presently free from any obstruction. With such an arrangement, it is possible to enhance the reliability of the information processing system without having to interrupt the data access from the information processor 100 to the storage system 200 even upon occurrence of obstruction or operation failure at any one of the paths 300 involved.

The path management program 130 also has the function of visually displaying the information as to the paths 300. Such display is performed, for example, at a display unit, which is one of the output devices (user interfaces) 106 as equipped by the information processing devices 100. Optionally, it is also possible to arrange the displaying of the information as to the paths 300 in such a way as to do it at an output device 106 owned by another information processor apparatus 100 or task client 1100, which may be connected via the port 103 of the information processor 100 of interest. The information concerning the paths 300 to be displayed include, for example, a present state of each path 300, an execution number of data input/output, a number of failures in proper execution of data input/output, an identification (ID) number of path 300, a title or name of path 300, an ID number of a logical unit 220 that can be accessed through path 300, ID information of storage system 200, ID information of a communication interface that storage system 200 owns, an updated time of the state of path 300, a message as to the state of path 300, etc.

Note here that the logical unit 220 as used herein may refer to a storage region which is set up by logical partition of the storage resources to be provided by the disk drive as built in the storage system 200. The logical unit 200 to be displayed is any one of the built-in logical units 220 owned by the storage system 200, which stores data that is sent with the path 300 as a communication channel and is an object of the data input/output request. Also note that the information concerning the path 300 to be displayed at the user interface may be designed so that information other than the above-noted information is displayed or alternatively designed so that part of such information is displayed.

As shown in FIG. 2, the path management program 130 includes a display control unit 131, a path adding/deleting execution unit 132, a service control unit 133, an alert monitoring unit 134, and a path management driver 135. The display control unit 131 is a program for displaying the above-stated information as to the paths 300 at an appropriate user interface. The display control unit 131 displays data at the user interface in cases where the data is stored in either a prespecified storage region of the memory 102 owned by information processor apparatus 100 or a video RAM (VRAM). When letting the information as to the paths 300 be displayed at one of the task clients 1100, the display control unit 131 that is executed on the task client 1100 displays the data being presently stored either in the prespecified storage region of the memory owned by the task client 1100 or in the VRAM at a built-in user interface of the client 1100. The path adding/deleting execution unit 132 is a program for performing addition and deletion of a path-or paths 300.

More specifically, the path add/delete execution unit 132 is arranged for example to accept an input of a path add/delete command 110 from the input device 105 equipped by the information processor apparatus 100 and then perform setup of a path or paths 300 in accordance with the instruction of such command. Regarding the addition and deletion of the path(s) 300, a detailed description will be presented later. The service control unit 133 is a program for performing control of an entirety of the path management program 130. For instance, when the obstruction monitor unit 134 detects obstruction of a path 300, the service control unit 133 receives from the alert monitor unit 134 a notice of the information concerning the obstruction of the path 300 and then writes the information as to the obstruction of path 300 into the error path information table 500. Thus it is possible for the display control unit 131 to read the contents of the error path information table 500 and then display the table contents at the user interface. The alert monitor unit 134 is a program for monitoring a present state of the path 300 for detection of any operation failure or obstruction thereof. Such obstruction monitoring is performed by monitoring the memory 102 as equipped by the information processing apparatus 100. Details will be discussed later. The path management driver 135 is a program for control of the communication for data input/output purposes to be done via the path 300. For example, as stated previously, this driver performs distribution processing of the data input/output request incoming from the application program 120 so that the load of each path 300 is dispersed or scattered, and also performs the processing for delivering the data input/output request to any normal path 300 whenever something wrong occurs at a path 300.

Respective types of functions that are provided by the information processor apparatus 100 in accordance with the illustrative embodiment are realizable in a way such that the CPU 101 executes the path management program 130 which is made up of several codes for performing various kinds of operations in accordance with this embodiment.

===About Storage System===

The individual storage system 200 includes a logical unit 220 and a disk control unit 210. The logical unit 220 as used herein should be understood to mean a storage region which is set up by logical partitioning of the storage resources that are provided by the disk drive as built in the storage system 200. The storage system 200 shown in FIG. 2 is equipped with two logical units: a logical unit (LU) No. 1 221 and an LU #2 222—say, LU1 and LU2 for simplicity purposes only. The disk drive may refer to a hard disk device or a semiconductor memory device or else, by way of example. The disk control unit 210 has a communication interface used to perform communication between itself and the information processor apparatus 100. Additionally the disk control unit 210 is operable to control access of the data being presently stored in the logical unit 220. The disk controller 210 may be designed in the form that it is built in the storage system 200 as shown in FIG. 2 or alternatively is modifiable so that it is externally connectable thereto. Still alternatively, each LU 221, 222 may be further divided into a plurality of partitions when the need arises. The partitions are storage regions that are configured by logical division of the logic unit 220.

Optionally the storage system 200 may be arranged to make up a disk array by using a plurality of disk drives, by way of example. In this case, the storage resources to be provided to the information processor apparatus 100 can also be arranged so that the resources are provided by multiple disk drives that are managed by redundant arrays of inexpensive disks (RAID).

===About Path Info Management Table===

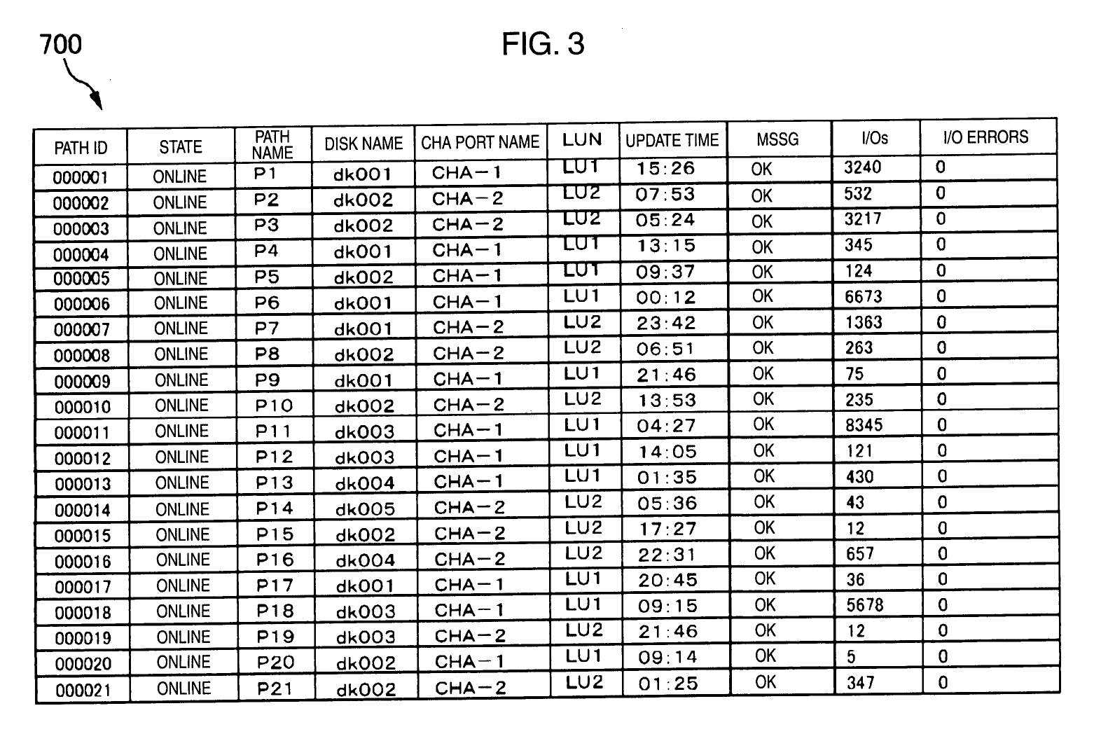

Next, a path information management table 700 in accordance with this embodiment is shown in FIG. 3.

The path information management table 700 is a table that is to be prepared and updated by the path management driver 135. For example, whenever a path 300 is added or deleted, the path management driver 135 receives from the path add/delete execution unit 132 certain information for update of the path information management table 700. And based on such information, the path management driver 135 updates the path information management table 700. The path information management table 700 has a “path ID” column, “status” column, “path name” column, “disk name” column, “CHannel Adapter (CHA) port name” column, “LUN” column, “update time” column, “message” column, “I/O execution number” column, and “I/O error number” column.

The “path ID” column is a column that is used to display the identification numbers of paths 300. The path ID number is added every time addition of a path 300 is done by the path add/delete execution unit 132, by way of example. The “status” column is a column for displaying whether any one of the information processing apparatuses 100 is presently communicable with one of the storage systems 200 via a path or paths 300. In cases where these are in a mutually communicable state, “online” is displayed; if not, then “offline” is displayed. For instance, in case obstruction occurs at a path 300 and thus they are incapable of communicating each other, “offline” is displayed. The “path name” column is the one that displays a title for identification of a path to be added in a way corresponding to the path ID.

The path name is assigned, for example, when the path add/delete command 110 is input to the information processor apparatus 100 by an operator who operates the information processor 100. The “disk name” column is a column which is for displaying the name of a disk as added in order to identify a disk drive that the storage system 200 owns, which disk drive is accessible via the path of interest. The disk name also is assigned upon inputting of the path add/delete command 110, by way of example. The “CHA port name” column is for displaying the CHA port name that is added in order to identify a communication interface of the communication interfaces owned by the disk control unit 210 for performing communication with the information processor apparatus 100, which interface makes up the path 300 of interest. This CHA port name also is assigned upon inputting of the path add/delete command 110, by way of example. The “LUN” column is for displaying an ID number that is added to the LU 220 accessible via the path 300. The LUN also is assigned upon inputting of the path add/delete command 110, for example. The “update time” column is for displaying a time point at which obstruction occurs in the path 300 or an instant whereat obstruction is removed. The “message” column is for displaying certain information required for analysis of any obstruction occurring at path 300. When obstruction is cured, there is displayed a message saying that obstruction is removed away through a recovery procedure. The “I/O execution number” column is for displaying an execution umber of data input/output processes as performed via the path 300 between the information processor apparatus 100 and the storage system 200. This number is updated by the path management driver 135 every time data input/output is done. The “I/O error number” column is for displaying an occurrence number of events that fail to properly perform the data input/output required. This is updated by the path management driver 135 whenever the intended data input/output is not completed successfully.

===About Error Path Info Table===

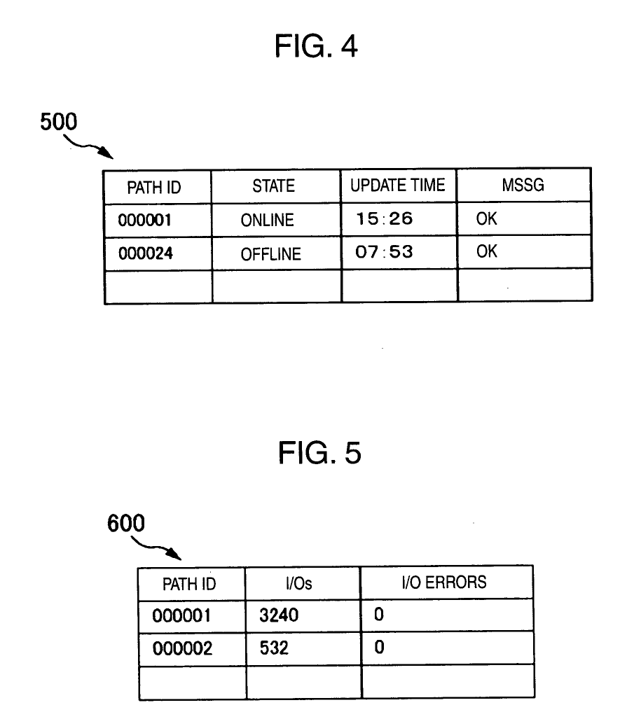

Next, an error path information table 500 in accordance with this embodiment is shown in FIG. 4.

The error path information table 500 is a table that is prepared and updated by the service control unit 133. The error path information table 500 may be formed and stored in a specific storage region on a memory 102 accessible by the display control unit 131 or alternatively in a VRAM when this VRAM is built in the information processor apparatus 100. The error path information table 500 has a “path ID” column, “status” column, “update time” column, and “message” column. When the service control unit 133 receives a notice of path obstruction from the obstruction monitoring unit 134, the service controller 133 writes into the error path information table 500 the above-noted information as to a path 300 that presently suffers from occurrence of obstruction. The information items to be written into respective columns are the same as corresponding ones of the path information management table 700 stated supra.

===About I/O Management Table===

Next, an I/O management table 600 in accordance with this embodiment is shown in FIG. 5.

The I/O management table 600 is created and updated by the path management driver 135. More specifically, when data input/output is done between the information processor apparatus 100 and the storage system 200, the I/O management table 600 is updated by the path management driver 135. The I/O management table 600 has a “path ID” column, “I/O execution number” column, and “I/O error number” column. The information items to be written into respective columns are the same as corresponding ones of the path information management table 700 stated previously.

===About Path Management===

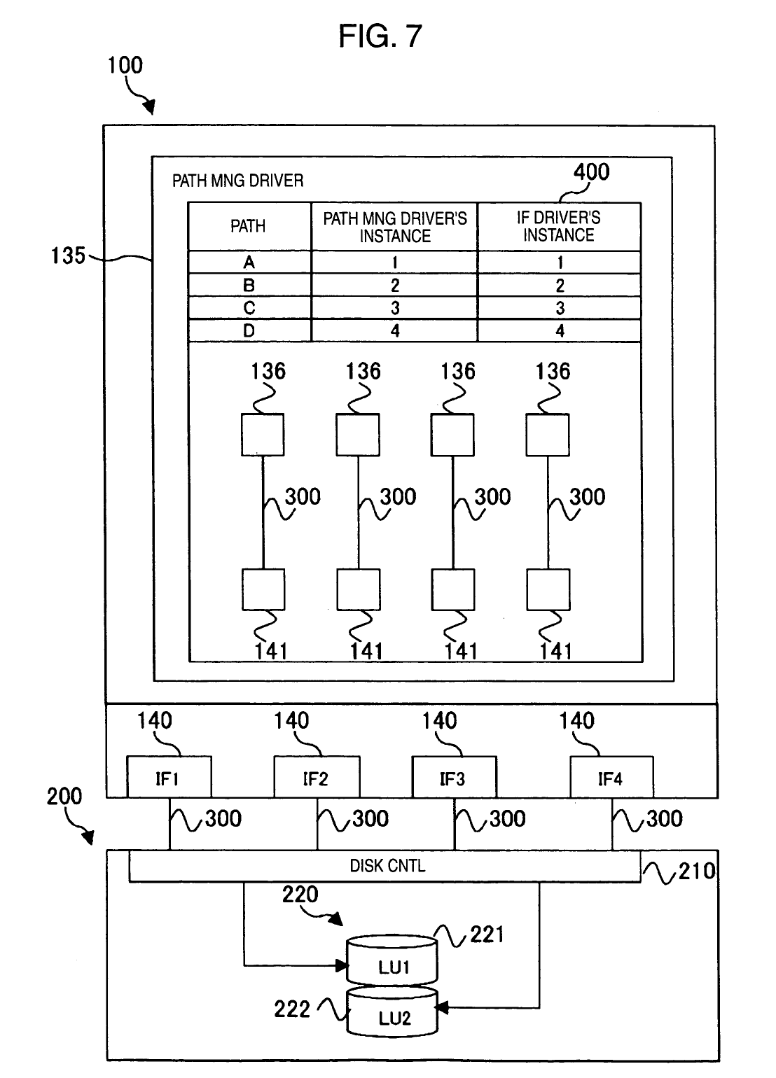

Referring next to FIG. 7, there is shown a block diagram for explanation of a management procedure of the paths 300 in the path management program 130 in accordance with this embodiment.

The management of the paths 300 is performed in such a way that the path management driver 135 manages or administrates the path management table 400 to be prepared and updated by the path add/delete execution unit 132.

The path management table 400 has a “path” column, “path management driver's instance” column, and “interface driver's instance” column. The “path” column is a column which is used to store therein the identification information of the paths 300 under management. Examples of the identification information are a path ID and a path name, either one of which is employable on a case-by-case basis. The “path management driver's instance” column is the one that is used to store the instance of the path management driver 135 which performs the control of communications via the path(s) 300. The “interface driver's instance” column is for storage of the instance of the interface driver, which is a program for control of the IF 140. And a correspondence established between the path management driver's instance 136 and the interface driver's instance 141 is managed and handled by the path management driver 135 whereby the management of paths 300 is performed.

The adding/deleting of a path 300 should be understood to mean a process for adding or deleting any one of the correspondences between the path management driver's instance 136 and the interface driver's instance 141 shown in FIG. 7 and for adding/deleting the information of the path 300 to or from the path management table 400 for management of the information of physical paths. Executing this processing results in the information processor apparatus 100 and storage system 200 being connected together in a hardware sense, with the lack of a chance to refer to the path's information from a view point of the path management. The timing of such path add/delete event is when the operator executes the path add/delete command 110.

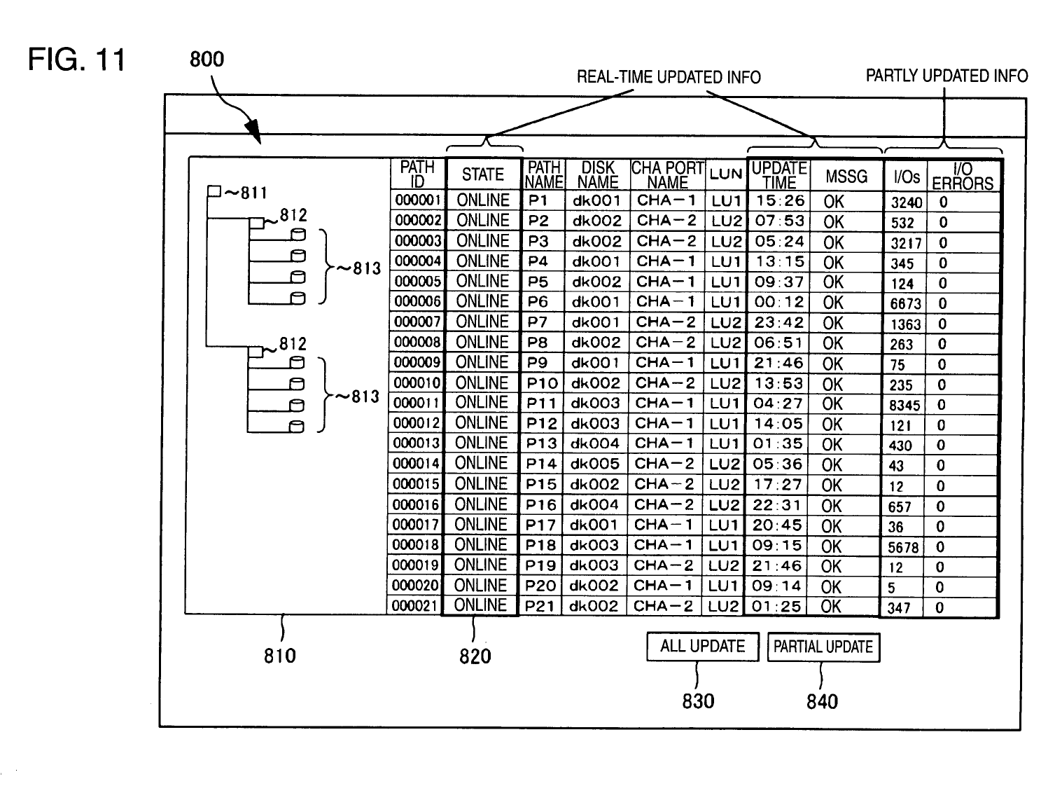

Additionally, with regard to a path that is connected in a hardware sense upon start-up of the path management program 130, this path is recognized by the path management program 130 and thus is reflected onto the path management table 400 through the path add/delete processing in the way stated supra. On the other hand, as for a path that is newly connected by means of a hardware scheme during operation after startup of the path management program 130, such path is no longer recognizable by the path management program 130. In FIG. 11, it is also possible to employ an arrangement which provides an information column of a path that is not yet reflected to the path management table 400 but is connected in a hardware sense in addition to the constituent information items (such as the path name, disk name, CHA port name, LUN, etc.) of the paths (reflected onto the path management table 400), displays the information of the path that is connected upon startup of the path management program 130 in the initial state, collects the hardware-based connection situations in relation to any path that is newly connected during system handling after startup of the path management program 130 in a way responding to receipt of an update request or the like, and then displays the result in the table of FIG. 11.

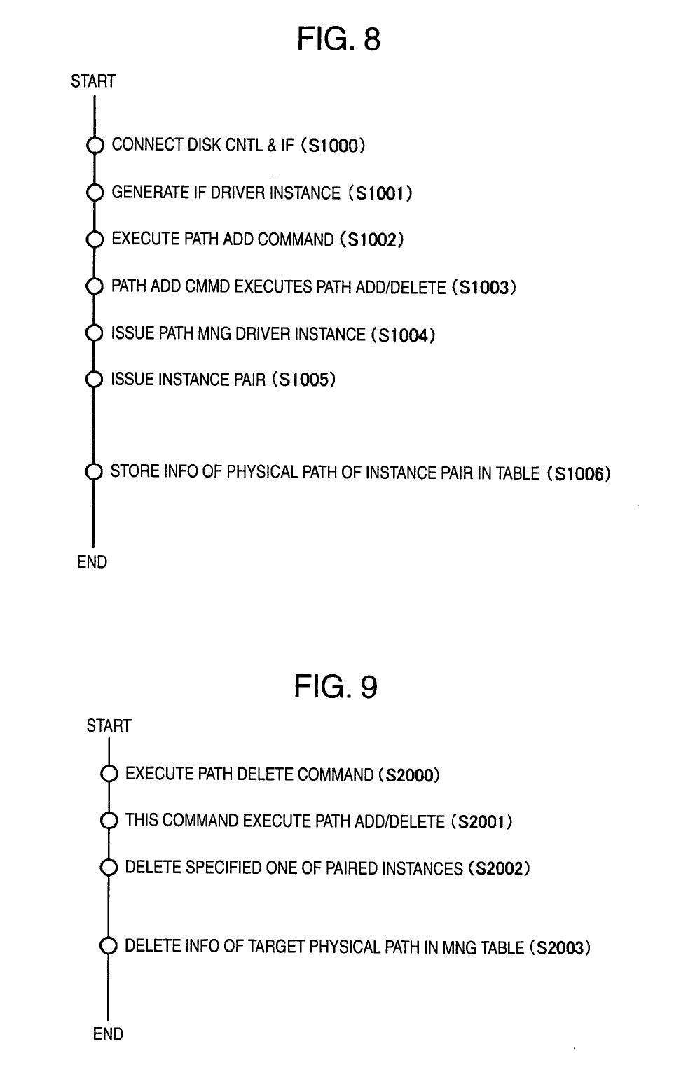

See FIGS. 8 and 9, which show flow charts indicative of processing flows for adding and deleting a path 300, respectively.

In the case of adding a path 300, firstly connect the disk control unit 210 and the IF 140 together (at step S1000 of FIG. 8). This is performed in a way such that the operator who is responsible to manage the information processing system connects an information processor apparatus 100 to a storage system 200, by way of example. When this is done, an interface driver's instance 141 is created (at step S1001). The creation of the interface driver's instance 141 is carried out, for example, by an operating system to be executed by the information processor 100. Next, when the operator inputs a path add command 110 from the input device 105 to the information processor 100 (step S1002), the path add/delete execution unit 132 of the path management program 130 is executed (S1003). If this is the case, the path management driver's instance 136 is created by the path add/delete execution unit 132 (S1004). Next, the path add/delete execution unit 132 creates a pair of path management driver's instance 136 and interface driver's instance 141 (S1005). Then, by the path add/delete execution unit 132, the pair of path management driver's instance 136 and interface driver's instance 141 thus created is added to the path management table 400 (S1006). Whereby the adding of the path 300 is performed.

On the other hand, in the case of deleting a path 300, the operator inputs a path delete command 110 to the information processor apparatus 100 (at step S2000 in FIG. 9). When this is done, the path add/delete execution unit 132 is executed (at step S2001); then, a pair of instances 136 and 141 corresponding to the path 300 that is presently assigned by the path delete command 110 is deleted by the path add/delete execution unit 132 from the path management table 400 (S2002, S2003). Whereby the deletion of the path 300 is done.

===About Path Components===

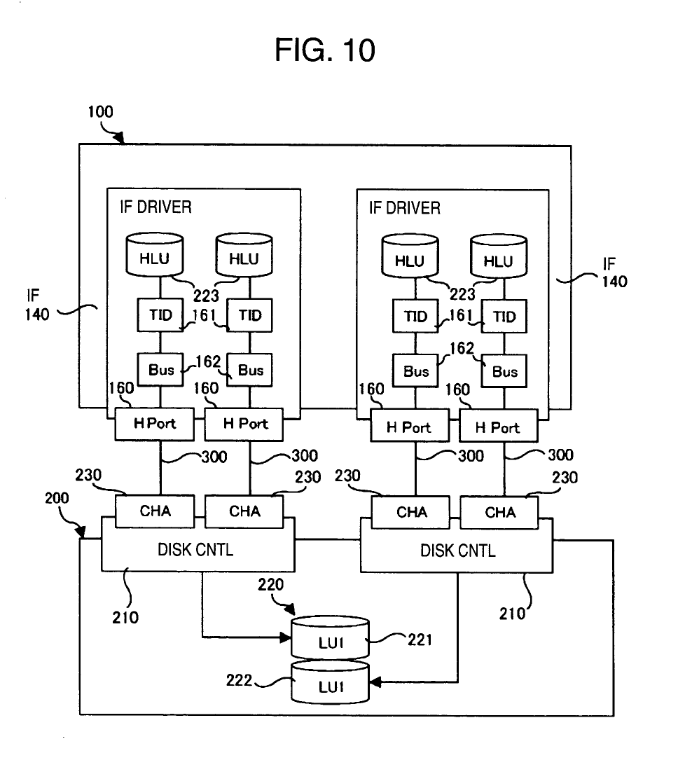

An explanation will next be given of parts or components that make up the paths 300 with reference to FIG. 10. As shown herein, the individual path 300 is structured from hardware or software components including, but not limited to, a Host Logical Unit (HLU) 223, Target ID (TID) 161, Bus 162, Host bus adapter Port (HPort) 160, CHannel Adapter Port (CHAPort) 230, disk control unit 210, and LU 220. The HLU 223, TID 161, Bus 162 and HPort 160 are the concepts as used in small computer system interface (SCSI) communication standards, and indicates a host logical unit, target ID, logical bus, and host bus adapter-side port, respectively. CHAPort 230 denotes a port of the disk control unit 210. Obviously the components making up the path 300 should not exclusively be limited to the ones stated above: more than one of the components above may be made unnecessary in a way depending upon the system to be established; components other than the above-noted ones may also be used to make up the paths 300.

===About Display to User Interface===

Turning next to FIG. 11, there is shown a way of visually displaying the information concerning the paths 300 in accordance with this embodiment at the user interface of information processor apparatus 100. Shown in FIG. 11 is the manner that the information as to the paths 300 is displayed in the form of a window screen, which is displayed on the screen of a display unit that is an output device 106 of the information processor 100. Displaying of such information as to the paths 300 onto the window screen is performed by the display control unit 131.

As shown in FIG. 11, a folder structure display part 810 and a path state display part 820 are displayed on the window screen in accordance with this embodiment. Displaying these parts permits visual indication of the information as to the paths 300.

The structure display part 810 is the one that indicates the constituent components or elements that the information processing system includes therein—that is, the information processor apparatuses 100, storage systems 200, and LUs 220 built in the storage systems 200 by use of icons 811, 812 and 813, respectively, to thereby represent respective arrangements in the form of a hierarchical tree-like structure. By selecting an icon using an input device 105 such as a mouse or the like, the information concerning a path 300 pertaining to the constituent element that is indicated by such selected icon is displayed in the path state display part 820. An example is that when selecting an icon 811 indicative of the information processor apparatus 100, the information as to a specific path 300 operatively related to this information processor 100 is displayed in the path state display part 820.

Displayed in the path state display part 820 is certain information as to the path 300 pursuant to a selected portion in the structure display part 810. The information to be displayed is “path ID,” “status,” “path name,” “disk name,” “CHA port name,” “LUN,” “update time,” “message,” “I/O execution number,” and “I/O error occurrence number.” These information items are based on the information to be stored in the path information management table 700, the I/O management table 600 and/or the error path information table 500.

When updating the information being displayed in the path state display part 820, the input device 105 such as a mouse or else is used to select and click on either an “all update” icon button or a “partial update” button. When clicking on the “all update” button, all the information items being displayed in the path state display part 820 are updated in contents. On the other hand, when clicking on the “partial update” button, part of the information being displayed at the path state display part 820—in the example shown in FIG. 11, the information of “I/O execution number” column and “I/O error” column—is updated. Obviously this may be modifiable so that any other information items are updated when clicking on the “partial update” button.

In case clicking on the “all update” button results in the display control unit 131 receiving an input for updating the information to be displayed on the display, the display controller 131 requests the path management driver 135 to provide all the information items being displayed in the path state display part 820. In responding thereto, the path management driver 135 attempts to read certain information corresponding to all the items to be displayed in the path state display part 820 out of the path information management table 700 and then write them into either a specific storage region of memory 102 or a VRAM. After completion of such writing, the path management driver 135 notifies the display controller 131 of the fact that the write required is completed. The display controller 131 reads the above-noted information from either the specific storage region or the VRAM to thereby display at the user interface. Whereby, it is possible to update all the information items being displayed at the user interface.

Alternatively, when the “partial update” icon button is clicked so that the display control unit 131 receives an input for updating the information being displayed on the display, the display control unit 131 requests the path management driver 135 to provide certain ones of the information items being displayed in the path state display part 820—here, the information items of “I/O execution number” and “I/O error number.” When this is done, the path management driver 135 reads the information being presently stored in the I/O management table 600 and then writes it into either the specific storage region of memory 102 or the VRAM. After completion of the writing, the path management driver 135 notifies the display controller 131 of completion of the write required. The display controller 131 reads the above-noted information out of either the specific storage region or the VRAM and then displays it at the user interface. Whereby, it is possible to update only specified one or ones of the information items being displayed in the user interface—here, the information items of “I/O execution number” and “I/O error number.” With the ability to update the information of “I/O execution number,” it is possible to become aware of the exact state of load dispersion (load balance) of each path 300 between the information processor apparatus 100 and storage system 200. In addition, with the capability to update the information of “I/O error number,” it is possible to be aware of the frequency of obstructions occurred in the past, even with regard to a path 300 that is presently set in the “online” state.

It should be noted that it is also possible to display in the path state display part 820 several items other than the items shown in FIG. 11; for example, “I/O execution number from the last update event,” “I/O error number from the last update event,” “time elapsed from the last update event,” etc. In this case, displayed at the path state display part 820 are an I/O execution number, I/O error number and elapsed time as measured after the last selection and clicking of the “all update” or “partial update” button. In order to display the “I/O execution number from the last update event,” “I/O error number from the last update event,” and “time elapsed from the last update event” in the path state display part 820, one exemplary approach is to provide in either the path information management table 700 shown in FIG. 3 or the I/O management table 600 shown in FIG. 5 specific columns for storage of the “I/O execution number from the last update event,” “I/O error number from the last update event” and “time elapsed from the last update event.” And, an arrangement is employed so that selection and clicking of the “all update” or “partial update” result in these values being displayed at the user interface and then zero-cleared. With such an arrangement, the “I/O execution number from the last update event,” “I/O error number from the last update event” and “time elapsed from the last update event” are successfully displayed to thereby make it possible to be aware of the I/O execution number and I/O error occurrence number within a prespecified length of time period.

As apparent from the foregoing, this embodiment is specifically arranged to update at least part of the information when the display control unit 131 receives an input for updating the information to be displayed. Thus it is possible to eliminate or at least greatly reduce the processing load to the information processor apparatus 100 otherwise occurring due to execution of unnecessary updating processes. In addition, it becomes possible to perform path information updating operations in accordance with the needs of the operator who is responsible in handling of the information processing system, by updating an entirety or part of the information in response to receipt of the input for updating the information to be displayed—in other words, by updating the information in reply to an input of either “all update” or “partial update.” For instance, in cases where the updating of the information being displayed at the user interface has not been done for an increased length of time period, it is possible by simply clicking on the “all update” icon button to update all the information items to the latest ones at a time. On the other hand, when wanting to know a present state of data input/output processing which is continually changeable over time by way of example, it is possible by clicking on the “partial update” button to update the display contents as to such data input/output. Whereby, it is possible to suppress or minimize the processing loads of the information processor apparatus 100 at the time of updating, which in turn makes it possible to effectively perform the information updating in a way pursuant to the operator's needs. In addition, the time taken to update the information is shortened in length, thereby enabling any required information to be displayed promptly without any appreciable time lags. Furthermore, in cases where the information as to the path status is displayed at any one of the enterprise clients 1100 shown in FIG. 1, it is possible to suppress the amount of these information items to be passed and delivered via the LAN 1000, thus making it possible to lessen the workload of LAN 1000.

Additionally, in accordance with this embodiment, it is possible to update at least part of the information being displayed in a way pursuant to a present state of the path 300 of interest. An example is that when detecting occurrence of obstruction at the path 300 or alternatively when detecting recovery of such obstruction, the updating of certain information items at least concerning the path 300's obstruction—for example, the “status,” “message” and “update time” columns—is performed without having to click on either the “all update” or “partial update” button. In FIG. 11, such updating is recited as the real time update. In case obstruction occurs at the path 300, the display content of “state” column is updated from “online” to “offline.” And at the “message” column, a display is done to indicate occurrence of obstruction or operation failure. Further, the time point being displayed in the “update time” column is updated. In case such obstruction is removed and thus recovery is done, the display of “status” column is updated from “offline” to “online”; at the same time, the display contents of “message” and “update time” columns also are updated.

The path management driver 135 that controls communications for data input/output to be done between any one of the information processor apparatuses 100 and its aimed one of the storage systems 200 is operable to write into the memory 102 certain obstruction information such as the path ID of a path 300 acting as a communication path of the communication and an error message and others whenever the driver detects that the communication for data input/output was not completed successfully. When the obstruction monitor unit 134 detects that such obstruction information is written by the path management driver 135 into the memory 102, this monitor unit 134 notifies the service control unit 133 of the obstruction information. Then, based on the obstruction information, the service controller 133 updates the contents of the error path information table 500 which is stored either in the specific storage region of the memory 102 or in the VRAM. Thus it is possible by the display controller 131 to update certain ones of the information items being displayed at the user interface—that is, the information items in the “status,” “message” and “update time” columns. Additionally the service controller 133 permits issuance of a data input/output request to the storage system 200 through the path management driver 135, with respect to the path 300 that is presently registered to the error path information table 500. Upon receipt of a status command indicative of proper or normal termination, delete the entry of this path 300 from the error path information table 500. Whereby, in the case of recovery of the obstruction of the path 300, it is possible to update certain information items concerning the obstruction of path 300—for example, the items in the “status,” “message” and “update time” columns—of the information to be displayed by the display controller 131 at the user interface.

===Table Update Processing===

An explanation will next be given of the way of updating the path information management table 700 and error path information table 500 plus I/O management table 600 in accordance with this embodiment in the event that communication for data input/output is done between the information processor apparatus 100 and storage system 200.

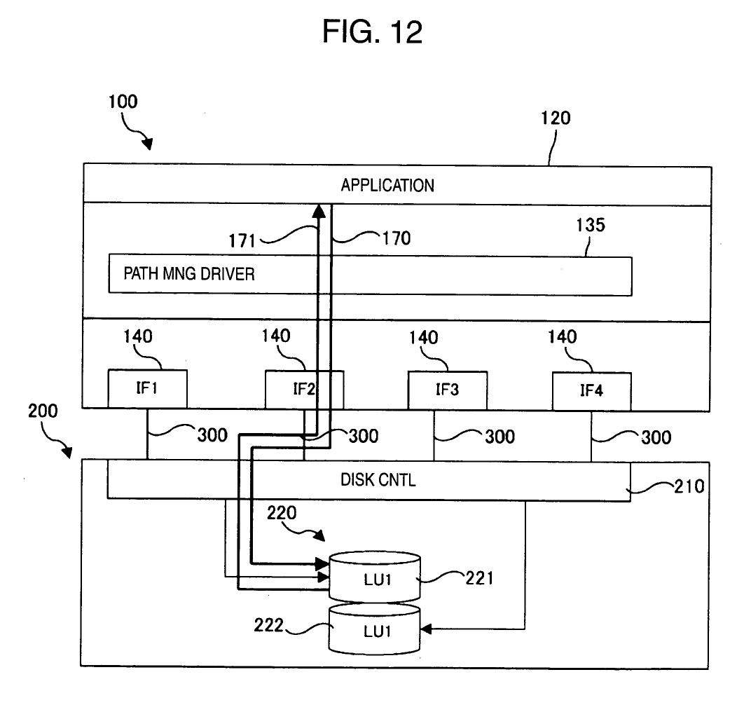

First, one specific case where the paths 300 in accordance with this embodiment are normal in operability will be explained with reference to FIG. 12. As shown in FIG. 12, when a data input/output request 170 is transmitted from the application program 200, this data input/output request 170 is sent forth toward the storage system 200 through the path management driver 135, IF 140, path 300, and disk control unit 210. Then, access to the data being presently stored in LU 220 is performed by the disk controller 210. In case the data input/output request is a write request, data is written into LU 220. Thereafter, the storage system 200 sends to the path management driver 135 a status command 171 indicating successful termination of the access. Alternatively when the data input/output request is a readout request, the storage system 200 sends read data to the application program 120. The path management driver 135 counts up an I/O execution number being presently stored in the I/O management table 600 and path information management table 700 as provided in the memory 102. Whereby, the I/O management table 600 and path information management table 700 are updated.

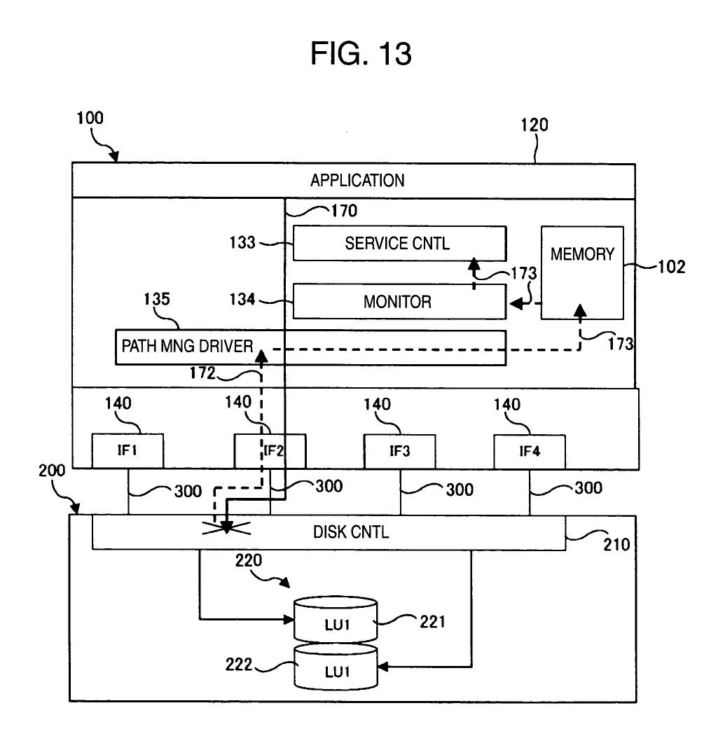

Next, another case where obstruction is occurring at one of the paths 300 in accordance with this embodiment will be discussed with reference to FIG. 13. As shown herein, when a data input/output request 170 is sent from the application program 120, the storage system 200 sends forth to the path management driver 135 a status command 172 indicating that access is ended with failure, i.e., abnormal access termination. By receipt of such status command indicative of abnormal access termination, the path management driver 135 detects that obstruction occurs at the path 300. Then, the path management driver 135 counts up the I/O error number being presently stored in the I/O management table 600 and path information management table 700 as provided in the memory 102. Thus the I/O management table 600 and path information management table 700 are updated.

In addition, the path management driver 135 writes into the memory 102 certain obstruction information 173 involving the path ID of a path 300 suffering from occurrence of obstruction, path state, error message, and a time of receipt of the status command indicative of abnormal termination. The obstruction monitor unit 134 monitors the memory 102 without interruption. When detecting that the obstruction information 173 was written by the path management driver 135 into the memory 102, the monitor 134 acquires the obstruction information 173 from the memory 102 and then passes it to the service control unit 133. And based on the obstruction information 173, the service controller 133 writes the path ID, path 300's state, update time and message into the error path information table 500 of either the specific storage region of memory 102 or the VRAM. Thus the error path information table 500 is updated.

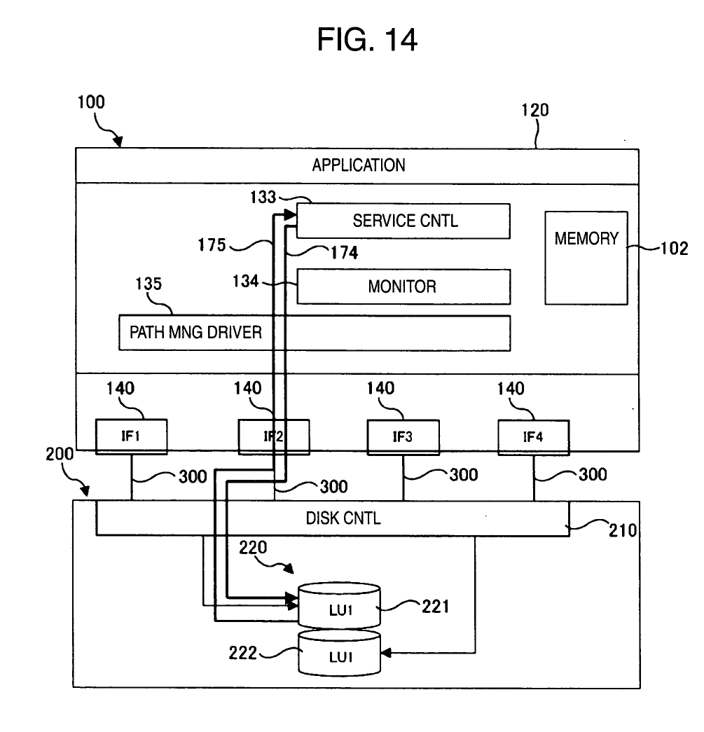

On the other hand, the service controller 133 generates and issues a data input/output request to the storage system 200 via the path management driver 135, with respect to the path being presently registered to the error path information table 500. This is in order to monitor or “watchdog” the recovery of obstruction of a path 300 that presently suffers from occurrence of such obstruction. Its situation is shown in FIG. 14. Upon receiving of a status command indicative of normal completion from the storage system 200, delete the information as to this path from the error path information table 500. With this scheme, it is possible to perform updating of the error path information table 500 with respect to the path 300 at which the obstruction is cured. Optionally the transmission of the data input/output request to be performed by the service controller 133 may be designed so that the same is done periodically at equal time intervals or non-periodically at variable intervals.

While the illustrative embodiment has been described above, this embodiment is arranged so that at least part of the information is updated when the display control unit 131 receives an input for updating the information to be displayed at the user interface. With such an arrangement, it becomes possible to perform updating of the information concerning the path or paths 300 in a way pursuant to the needs of the operator who is responsible for monitoring the paths 300. It is also possible to eliminate the processing loads relative to the information processor apparatuses 100 otherwise occurring due to execution of unnecessary updating tasks. Also importantly in the this embodiment, the updating of a plurality of information items as to the paths 300 to be displayed at the user interface of information processor apparatus 100 is performed in such a way that the entirety or part of the information being displayed is updated in response to an input being presently received—for example, in accordance with the input of either “all update” or “partial update.” This makes it possible to perform update of the path information in a way pursuant to the needs of the operator who monitors the status of such paths 300. In particular, upon receipt of the input of “partial update,” it is possible to suppress or minimize an increase in processing load of information processor apparatus 100, which in turn makes it possible to rapidly perform updating of certain information that meets the operator's needs.

A further advantage lies in an ability to update the information as to obstruction to be displayed at the user interface in accordance with a present state of each path 300—for example, in a case-sensitive way depending upon when obstruction occurs at path 300 or when such obstruction is cured or recovered—even if the operator does not click on either the “all update” or “partial update” button. This makes it possible to quickly recognize a change in state of the individual path 300; for example, upon occurrence of obstruction in the information processing system, it becomes possible to quickly take necessary corrective action.

Although the invention has been described with reference to specific embodiments, the description is illustrative of the invention and is not to be construed as limiting the invention. Various modifications and alternations may occur to those skilled in the art without departing from the true spirit and scope of the invention as defined by the appended claims. The invention should be interpreted to include various possible equivalents thereof.

It is possible to provide a new and improved program, information processing apparatus, and control method of information processing apparatus.

1. A program for use in an information processing apparatus having a function of displaying at a user interface a plurality of information items concerning a communication path for sending a data input/output request to a storage device, said program causing said apparatus to execute at least either one of the steps of:
updating at least one of said information items being displayed in accordance with a state of said communication path; and
updating at least one of said information items being displayed when receiving from said user interface an input for updating said information being displayed.

2. The program according to claim 1, wherein said step of updating at least one of said information items being displayed in accordance with a state of said communication path is a step of updating, when detecting that obstruction occurs at said communication path, at least one of said information items being displayed which concerns the obstruction of said communication path.

3. The program according to claim 1, wherein in accordance with an input for updating said information being displayed, all of said information items being displayed or part of said information items being displayed is updated.

4. The program according to claim 3, wherein said part of said information to be updated includes at least one of an execution number of data input/output as performed between said storage device and said information processing apparatus and a number indicative of failure in proper execution of said data input/output.

5. An information processing apparatus having a function of displaying at a user interface a plurality of information items concerning a communication path for sending a data input/output request to a storage device, said apparatus comprising at least one of:
means for updating at least one of said information items being displayed in accordance with a state of said communication path; and
means for updating at least one of said information items being displayed when receiving from said user interface an input for updating said information being displayed.

6. The information processing apparatus according to claim 5, wherein said means for updating at least one of said information items being displayed in accordance with a state of said communication path is operable to update, when detecting that obstruction occurs at said communication path, at least one of said information items being displayed which concerns the obstruction of said communication path.

7. The information processing apparatus according to claim 5, wherein in accordance with an input for updating said information being displayed, all of said information items being displayed or part of said information items being displayed is updated.

8. The information processing apparatus according to claim 7, wherein said part of said information to be updated includes at least one of an execution number of data input/output as performed between said storage device and said information processing apparatus and a number indicative of failure in proper execution of said data input/output.

9. A control method of an information processing apparatus having a function of displaying at a user interface a plurality of information items concerning a communication path for sending a data input/output request to a storage device, said method comprising at least one of the steps of:
updating at least one of said information items being displayed in accordance with a state of said communication path; and
updating at least one of said information items being displayed when receiving from said user interface an input for updating said information being displayed.

10. The control method according to claim 9, wherein said step of updating at least one of said information items being displayed in accordance with a state of said communication path is a step of updating, when detecting that obstruction occurs at said communication path, at least one of said information items being displayed which concerns the obstruction of said communication path.

11. The control method according to claim 9, wherein in accordance with an input for updating said information being displayed, all of said information items being displayed or part of said information items being displayed is updated.

12. The control method according to claim 11, wherein said part of said information to be updated includes at least one of an execution number of data input/output as performed between said storage device and said information processing apparatus and a number indicative of failure in proper execution of said data input/output.
